(19) United States
(12) Patent Application Publication
(10) Pub. No.: US 2002/0010872 A1
(43) Pub. Date: Jan. 24, 2002

(54) Multi-agent synchronized initialization of a clock forwarded interconnect based computer system

(76) Inventors: Stephen R. Van Doren, Northborough, MA (US); Barry A. Maskas, Sterling, MA (US)

Correspondence Address: CESARI AND MCKENNA, LLP, 88 BLACK FALCON AVENUE, BOSTON, MA, 02210, US

(21) Appl. No.: 09/871,090

(22) Filed: May 31, 2001

Related U.S. Application Data
(60) Provisional application No. 60/208,151, filed on May 31, 2000.
(60) Provisional application No. 60/208,442, filed on May 31, 2000.

(51) Int. Cl. G06F 1/12; H04L 5/00; G06F 13/42

(52) U.S. Cl. 713/400

(57) ABSTRACT

A technique synchronizes clock forwarded interface circuits of a multiprocessor system having a plurality of nodes interconnected by a hierarchical switch. Each node includes a plurality of agents coupled to a local switch over clock forwarded links attached to the interface circuits. The local switch includes a unique command port that interacts with the interface circuits to distribute clock forwarding synchronization messages among the agents of each node. These synchronization messages are used as start events that activate the clock forwarded interface circuits to thereby insure proper synchronous operation of these circuits.

### CROSS-REFERENCE TO RELATED APPLICATIONS

The present application claims priority from the following:

U.S. Provisional Patent Application Ser. No. 60/208,151, which was filed on May 31, 2000, by Barry Maskas and Stephen Van Doren for a MULTI-AGENT SYNCHRONIZED INITIALIZATION OF A CLOCK FORWARDED INTERCONNECT BASED COMPUTER SYSTEM; and

U.S. Provisional Patent Application Ser. No. 60/208,442, which was filed on May 31, 2000, by Stephen Van Doren for a HOT SWAP AND STARTUP MULTI-AGENT CLOCK SYNCHRONIZATION, which are both hereby incorporated by reference.

### BACKGROUND OF THE INVENTION

1. Field of the Invention

The present invention generally relates to synchronous clock forwarding in a computer system and, more specifically, to synchronization of clock forwarded circuits during system power-up and “hot swap” in a multiprocessor system.

2. Background Information

High performance server computers, particularly switch-based multiprocessor systems, typically utilize synchronous clock forwarded interface circuits to provide high data bandwidth on relatively narrow interconnects or links associated with the interface circuits. In many cases, these systems also support “hot swap” of their constituent components interconnected by the synchronous clock forwarded links. Clock forwarding is a technique in which data transferred between the components is accompanied by a clock signal. Synchronous clock forwarding further includes the element of a common perceived time frame between a sender and a receiver of the clock forwarded transfer. In particular, the common time frame defines a specific time at which all data bits of the clock forwarded transfer have been received or “clocked” into logic at the receiver, thereby allowing for maximum variability and propagation delay.

In a multiprocessor system having a plurality of subsystems or nodes interconnected by a switch, there may be a plurality of clock forwarded links that require synchronization during a power up sequence and/or reset procedure. Moreover, during a hot-swap event where, e.g., a new node or “agent” is added to the system, one or more of the clock forwarded links may require synchronization. An approach for implementing clock forwarding in such a multiprocessor system involves a “pin-and-wire” arrangement that utilizes a plurality of synchronization signals. According to this arrangement, a synchronization signal is needed for each sender and receiver interface circuit in the system. If a clock forwarded link is “sliced” across multiple devices, such as application specific integrate circuits (ASICs), each ASIC requires a copy of the synchronization signal for that link. Furthermore, if a device is coupled to multiple links, as in the case of an ASIC of one of the system's switches, that ASIC requires one signal per supported link.

However, ASIC pin count is often a limiting factor in multiprocessor systems, particularly with respect to partitioning and implementation, because of the numerous pins needed to implement address/data clock forwarded links, as well as command and control information used to drive and manipulate those links. Accordingly, the pin-and-wire intensive solution described above is inefficient (and possibly impractical) for such a system. Asynchronous operation of each sender and receiver interface circuit to achieve lock based on data patterns is also generally inefficient. The present invention is directed to a technique for efficiently synchronizing clock forwarded links in a multiprocessor system based upon a power up or reset event. In addition, the invention is directed to a synchronous clock forwarding technique for efficiently synchronizing one or more links based upon a hot-swap event.

### SUMMARY OF THE INVENTION

The present invention comprises a technique for synchronizing clock forwarded interface circuits of a multiprocessor system having a plurality of nodes interconnected by a hierarchical switch. Each node includes a plurality of agents coupled to a local switch over clock forwarded links attached to the interface circuits. The local switch includes a unique command port that interacts with the interface circuits to distribute clock forwarding synchronization messages among the agents of each node. These synchronization messages are used as start events that “start up”(activate) the clock forwarded interface circuits to thereby insure proper synchronous operation of these circuits.

In the illustrative embodiment, the interface circuits coupled to the links function as complimentary senders and receivers of clock forwarded data transported over the links. Each clock forwarded link requires a pair of complimentary start events for initializing its sender and receiver interface circuits within the local switch and agents, which preferably include processors, memories, an input/output port (IOP) and a global port (GP) of a node. In the case of a processor, the start event is a cfinit signal, whereas in the case of the switch, the start event is a serial chain message. As described herein, the local switch derives various synchronization messages (“sync commands”) and start messages (“start-up commands”) from the serial chain that represent start events for the other agents of the node.

According to one aspect of the inventive technique, the command port and clock forwarded interfaces cooperate to provide a broadcast mode that allows simultaneous synchronization of all links in a node during power-up or reset sequences. For this mode, the local switch derives a broadcast sync command from the serial chain and transmits the command to clock forwarded interface circuits of each agent (memory, IOP and GP) present in the node. In addition, the switch transmits a start-up command to each of its clock forwarded interface circuits having a clock forwarded link coupled to each of the agents. The arrival of the broadcast sync and start-up commands at the clock forwarded interface circuits of the agents and switch together with the arrival of the cfinit signals at the clock forwarded interface circuits of the processors result in synchronous activation of all clock forwarded interfaces (and links) of the node.

According to another aspect of the technique, the command port may interact with the clock forwarded interfaces to provide a multi-cast mode that enables synchronization of as few as one link during a hot-swap procedure. Here, the local switch derives a multi-cast sync command from the serial chain message configured to specify activation of the clock forwarded interfaces associated with selected links within the node. The multi-cast sync command initiates a targeted synchronization process for the selected clock forwarded interfaces and links of an agent (such as a processor) without disturbing the other agents and associated links operating within the node. That is, targeted complimentary start events are created and delivered to the selected interface circuits during operation of the system in order to activate the selected links.

Advantageously, the invention provides a fixed latency for transfers between multiple agents (or modules and ASICs) within the multiprocessor system. In addition, the inventive technique allows components of the system to start up at precise times and hence eliminate problems associated with start up filtering of bad packets. Moreover, the technique described herein facilitates hot swap of agents at specified clock forwarded interface boundaries, since the start up operations can be tailored to a subset of the interfaces in the system. This, in turn, enables support of processor and node hot swap in the system.

### BRIEF DESCRIPTION OF THE DRAWINGS

The above and further advantages of the invention may be better understood by referring to the following description in conjunction with the accompanying drawings, in which like reference numbers indicated identical or functionally similar elements:

FIG. 1 is a schematic block diagram of a modular, symmetric multiprocessing (SMP) system having a plurality of Quad Building Block (QBB) nodes interconnected by a hierarchical switch;

FIG. 2 is a schematic block diagram of a QBB node coupled to the SMP system of FIG. 1;

FIG. 3 is a functional block diagram of circuits contained within a local switch of the QBB node of FIG. 2;

FIG. 4 is a schematic block diagram illustrating a synchronous clock forwarded interface circuit arrangement within a QBB node of the SMP system;

FIG. 5 is a highly schematized diagram illustrating the interaction between agents of a QBB node when synchronizing clock forwarded interface circuits in accordance with the present invention; and

FIG. 6 is a schematic block diagram depicting various registers that may be advantageously used with the present invention.

### DETAILED DESCRIPTION OF AN ILLUSTRATIVE EMBODIMENT

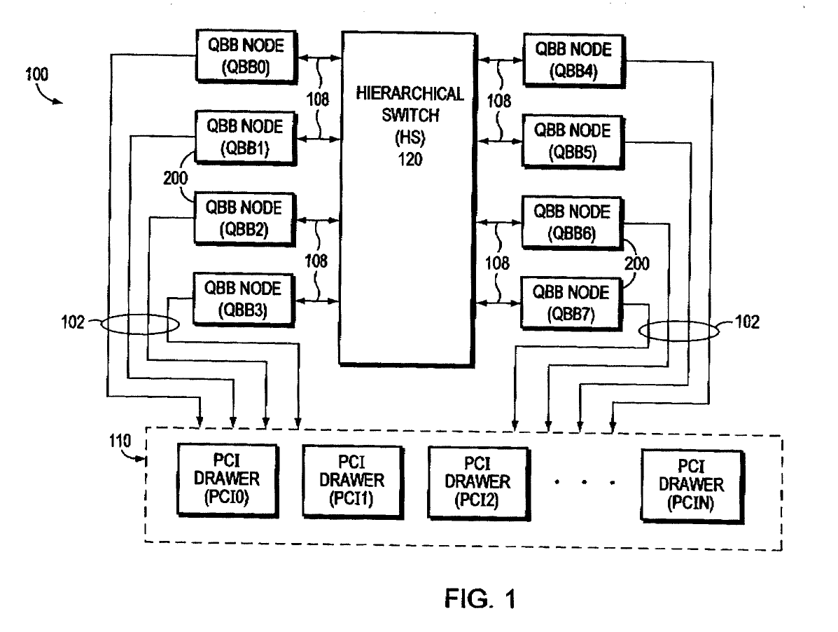

FIG. 1 is a schematic block diagram of a modular, symmetric multiprocessing (SMP) system 100 having a plurality of nodes 200 interconnected by a hierarchical switch (HS) 120. The SMP system further includes an input/output (I/O) subsystem 110 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising, inter alia, a plurality of processors, a plurality of memory modules, an I/O port (IOP) and a global port (GP) interconnected by a local switch. Each memory module may be shared among the processors of a node and, further, among the processors of other QBB nodes configured on the SMP system to create a distributed shared memory environment. A fully configured SMP system preferably comprises eight (8) QBB (QBBO-7) nodes, each of which is coupled to the HS 120 by a full-duplex, bi-directional, clock forwarded HS link 108.

Data is transferred between the QBB nodes 200 of the system 100 in the form of packets. In order to provide a distributed shared memory environment, each QBB node is configured with an address space and a directory for that address space. The address space is generally divided into memory address space and I/O address space. The processors and IOP of each QBB node utilize private caches to store data for memory-space addresses; I/O space data is generally not “cached” in the private caches.

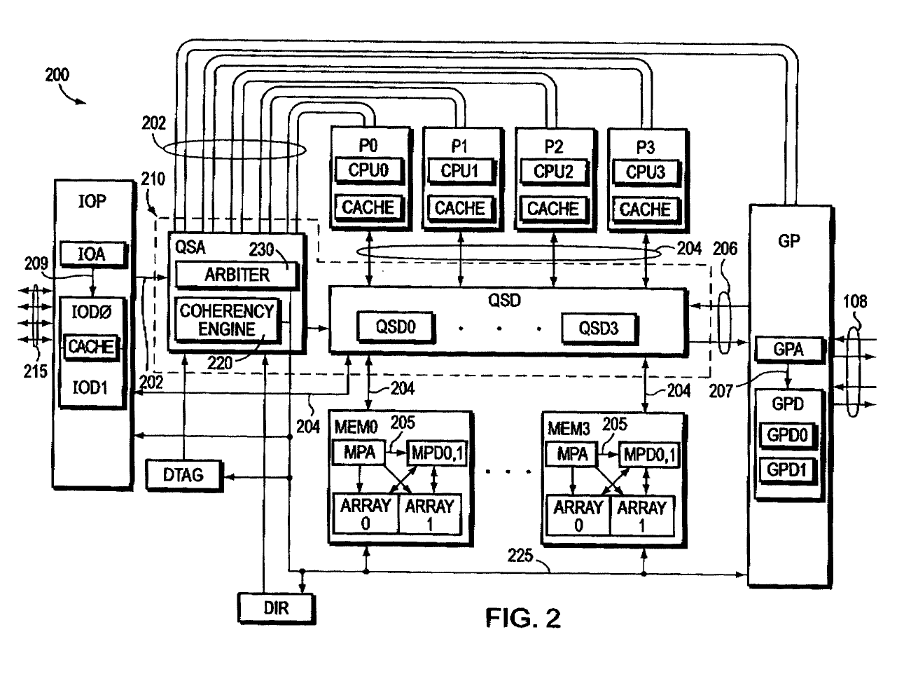

FIG. 2 is a schematic block diagram of a QBB node 200 comprising a plurality of processors (P0-P3) coupled to the IOP, the GP and a plurality of memory modules (MEMO-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hoses 102. As with the case of the SMP system, data is transferred among the components or “agents” of the QBB node 200 in the form of packets. As used herein, the term “system” refers to all components of the QBB node excluding the processors and IOP.

Each processor is a modern processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation of Houston, Tex., although other types of processor chips may be advantageously used. The load/store instructions executed by the processors are issued to the system as memory reference transactions, e.g., read and write operations. Each operation may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be advantageously used. It should be further noted that memory reference operations issued by the processors are preferably directed to a 64-byte cache line granularity. Since the IOP and processors may update data in their private caches without updating shared memory, a cache coherence protocol is utilized to maintain data consistency among the caches. In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects. That is, there is a set of address and data lines that couple each array with the memory interface logic.

The IOP preferably comprises an I/O address (IOA) ASIC and a plurality of I/O data (IOD0-1) ASICs that collectively provide an I/O port interface from the I/O subsystem to the QBB node. The IOP is connected to a plurality of local I/O risers (not shown) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via full duplex, bi-directional, clock forwarded GP links 206. The GP is further coupled to the HS 120 via a set of unidirectional, clock forwarded address and data HS links 108.

A plurality of shared data structures are provided for capturing and maintaining status information corresponding to the states of data used by the nodes of the system. One of these structures is configured as a duplicate tag store (DTAG) that cooperates with the individual hardware caches of the system to define the coherence protocol states of data in the QBB node. The other structure is configured as a directory (DIR) to administer the distributed shared memory environment including the other QBB nodes in the system. Illustratively, the DTAG functions as a “short-cut” mechanism for commands at a “home” QBB node, while also operating as a refinement mechanism for the coarse protocol state stored in the DIR at “target” nodes in the system. The protocol states of the DTAG and DIR are managed by a coherency engine 220 of the QSA that interacts with these structures to maintain coherency of cache lines in the SMP system 100.

The DTAG, DIR, coherency engine, IOP, GP and memory modules are interconnected by a logical bus, hereinafter referred to as an Arb bus 225. The Arb bus comprises a plurality of encoded command, address and data lines that enable communication among the QSA, MPA, IOA and GPA ASICs. Memory and I/O reference operations issued by the processors are routed by an arbiter 230 of the QSA over the Arb bus 225. The coherency engine and arbiter are preferably implemented as a plurality of hardware registers and combinational logic configured to produce sequential logic circuits, such as state machines. It should be noted, however, that other configurations of the coherency engine, arbiter and shared data structures may be advantageously used herein.

As described further herein, the MPA and QSA communicate with their respective MPD and QSD ASICs over front-end command buses; these buses are used to sequence data movement between the QSDs and the MPDs. Commands transmitted over the front-end command buses have a fixed timing relationship with commands issued over the Arb bus. The QSA may further communicate with its QSDs over back-end command buses. Each back-end command bus is associated with a processor, GP or IOP and controls, independent of the other command buses, data movement between the local switch and its associated processor, GP or IOP. The GPA and IOA also communicate with their respective GPDs and IODs over “inter-ASIC” command buses 207, 209 used to sequence data over the links coupling the GPDs and IODs to the QSDs.

Operationally, the QSA receives requests from the processors and IOP, and arbitrates among those requests (via the QSA arbiter 230) to resolve access to resources coupled to the Arb bus 225. If, for example, the request is a memory reference operation, arbitration is performed for access to the Arb bus based on the availability of a particular memory module, array or bank within an array. In the illustrative embodiment, the arbitration policy enables efficient utilization of the memory modules; accordingly, the highest priority of arbitration selection is preferably based on memory resource availability. However if the request is an I/O reference operation, arbitration is performed for access to the Arb bus for purposes of transmitting that request to the IOP. In this case, a different arbitration policy may be utilized for I/O requests and control status register (CSR) references issued to the QSA.

The unidirectional and bi-directional links 202, 204, 206 are preferably synchronous clock forwarded links configured to transport data and clock information. The clock information is used to synchronously load (“clock”) the accompanying data into buffers at a receiver circuit. For example, multiple commands may be transmitted by a sender circuit over the command/address links 202 wherein each command is accompanied by a clock signal used to load the command into collection logic circuitry at the receiver. The collection logic is used to bring the transmitted data into the clock domain of the receiver so that it can be interpreted by the receiver.

The period of the clock signals transmitted throughout the modular SMP system is preferably 9.6 nanoseconds (nsecs) yielding a frequency of 104 megahertz (MHz). However, data may be clocked into receiver circuits of the system on both leading and trailing edges of the clock signal; this effectively translates into a clock period of 4.8 nsecs yielding a frequency of 208 MHz. Each data transmitted and/or received on an edge of a clock signal is called a “flit” or a 1-bit time of data. For example, each request transmitted by a processor to the QSA is 4-bit times in length. In the illustrative embodiment, 14×4 bits of data are transmitted for each request issued by a processor to the QSA, whereas control information returned by the QSA to the processor may be either 2-bit or 4-bit times in length depending upon the type of packet (i.e., whether it is solely a command or command/address information packet).

In the illustrative embodiment, the sender and receiver circuits operate at the same frequency, but with clock signals slightly out of phase. Depending upon the amount of phase displacement and clock skew associated with the clock signals, the sender and receiver may be “synchronized” by assigning (i) a transmit start time to the sender for transmitting the clock forwarded signals and (ii) a receive start time to the receiver for clocking transmitted data into a native clock domain of the receiver. Assignment of these start times substantially guarantees that, at the receiver's start time, the data that was transmitted at the transmitter's start time, is stable within the receiver's native clock domain. In accordance with an aspect of the present invention described herein, a technique is provided to inform the sender and receiver circuits of their respective start times to thereby enable activation of a clock forwarded link.

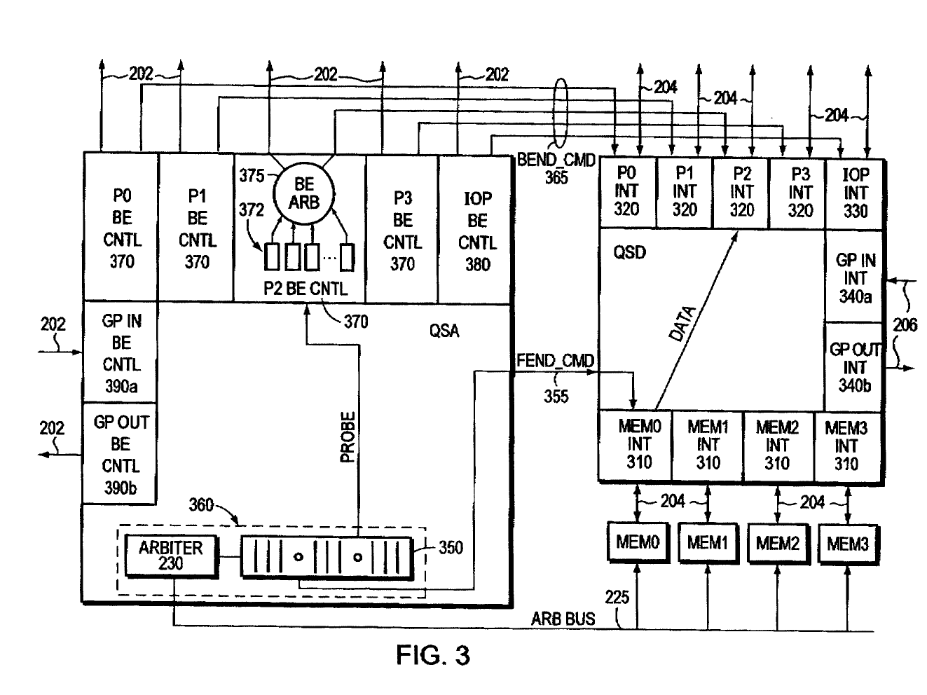

FIG. 3 is a functional block diagram of circuits contained within the QSA and QSD ASICs of the local switch 210 of a QBB node 200. Each QSD includes a plurality of memory (MEMO-3) interface circuits 310, each corresponding to a memory module. The QSD further includes a plurality of processor (P0-P3) interface circuits 320, an IOP interface circuit 330 and a plurality of GP (GPIN and GPOUT) interface circuits 340a,b. These interface circuits are configured to control data transmitted to/from the QSD over the bi-directional clock forwarded links 204 (for P0-P3, MEMO-3 and IOP) and the bi-directional clock forwarded links 206 (for the GP). Each interface circuit also contains storage elements that provide limited buffering capabilities with the circuits.

The QSA, on the other hand, includes a plurality of processor controller circuits 370, along with IOP and GP controller circuits 380, 390. These controller circuits (hereinafter “back-end controllers”) function as data movement engines responsible for optimizing data movement between respective interface circuits of the QSD and the agents corresponding to those interface circuits. The back-end controllers carry-out this responsibility by issuing commands to their respective interface circuits over a back-end command (Bend_Cmd) bus 365 comprising a plurality of lines, each coupling a back-end controller to its respective QSD interface circuit. Each back-end controller preferably comprises a plurality of queues coupled to a back-end arbiter (e.g., a finite state machine) configured to arbitrate among the queues. For example, each processor back-end controller 370 comprises a back-end arbiter 375 that arbitrates among queues 372 for access to a command/address clock forwarded link 202 extending from the QSA to a corresponding processor.

The memory reference operations issued to the memory modules are preferably ordered at the Arb bus 225 and propagate over that bus offset from each other. Each memory module services the operation issued to it by returning data associated with that operation. The returned data is similarly offset from other returned data and provided to a corresponding memory interface circuit 310 of the QSD. Because the ordering of operations on the Arb bus guarantees staggering of data returned to the memory interface circuits from the memory modules, a plurality of independent command/address buses between the QSA and QSD are not needed to control the memory interface circuits. In the illustrative embodiment, only a single front-end command (Fend_Cmd) bus 355 is provided that cooperates with the arbiter 230 and an Arb pipeline 350 to control data movement between the memory modules and corresponding memory interface circuits of the QSD.

The QSA arbiter and Arb pipeline preferably function as an Arb controller 360 that monitors the states of the memory resources and, in the case of the arbiter 230, schedules memory reference operations over the Arb bus 225 based on the availability of those resources. The Arb pipeline 350 comprises a plurality of register stages that carry command/address information associated with the scheduled operations over the Arb bus. In particular, the pipeline 350 temporarily stores the command/address information so that it is available for use at various points along the pipeline such as, e.g., when generating a probe directed to a processor in response to a DTAG look-up operation associated with stored command/address.

In the illustrative embodiment, data movement within a QBB node essentially requires two commands. In the case of the memory and QSD, a first command is issued over the Arb bus 225 to initiate movement of data from a memory module to the QSD. A second command is then issued over the front-end command bus 355 instructing the QSD how to proceed with that data. For example, a request (read operation) issued by P2 to the QSA is transmitted over the Arb bus 225 by the arbiter 230 and is received by an intended memory module, such as MEMO. The memory interface logic activates the appropriate SDRAM DIMM(s) and, at a predetermined later time, the data is returned from the memory to its corresponding MEMO interface circuit 310 on the QSD. Meanwhile, the Arb controller 360 issues a data movement command over the front-end command bus 355 that arrives at the corresponding MEMO interface circuit at substantially the same time as the data is returned from the memory. The data movement command instructs the memory interface circuit where to move the returned data. That is, the command may instruct the MEMO interface circuit to move the data through the QSD to the P2 interface circuit 320 in the QSD.

In the case of the QSD and a processor (such as P2), a command (such as a fill command) is generated by the Arb controller 360 and forwarded to the back-end controller 370 corresponding to P2, which issued the read operation. The controller 370 loads the fill command into a fill queue 372 and, upon being granted access to the command/address link 202, issues a first command over that link to P2 instructing that processor to prepare for arrival of the data. The P2 back-end controller 370 then issues a second command over the back-end command bus 365 to the QSD instructing its respective P2 interface circuit 320 to send that data to the processor.

In accordance with an aspect of the present invention, these command buses are also used for activating the interface/controller circuits associated with the clock forwarded links of the QBB node and SMP system. When activating all of the links in response to, e.g., a power-up sequence or reset procedure in a node, the Arb bus 225 and front-end command bus 355 are employed to distribute an appropriate link activation (“synch”) signal, as described herein. Yet, the modular SMP system also supports “hot swapping” of agents, such as processors or nodes, in the system. To that end, it may be necessary to deactivate the links to, e.g., a particular processor, remove that processor from the QBB node, insert another processor into the node and then restart only those links connected to the inserted processor. In accordance with another aspect of the present invention, the novel technique allows for activating selected clock forwarded links of an agent (such as a processor) utilizing the appropriate back-end command bus to transport such a synchronization signal.

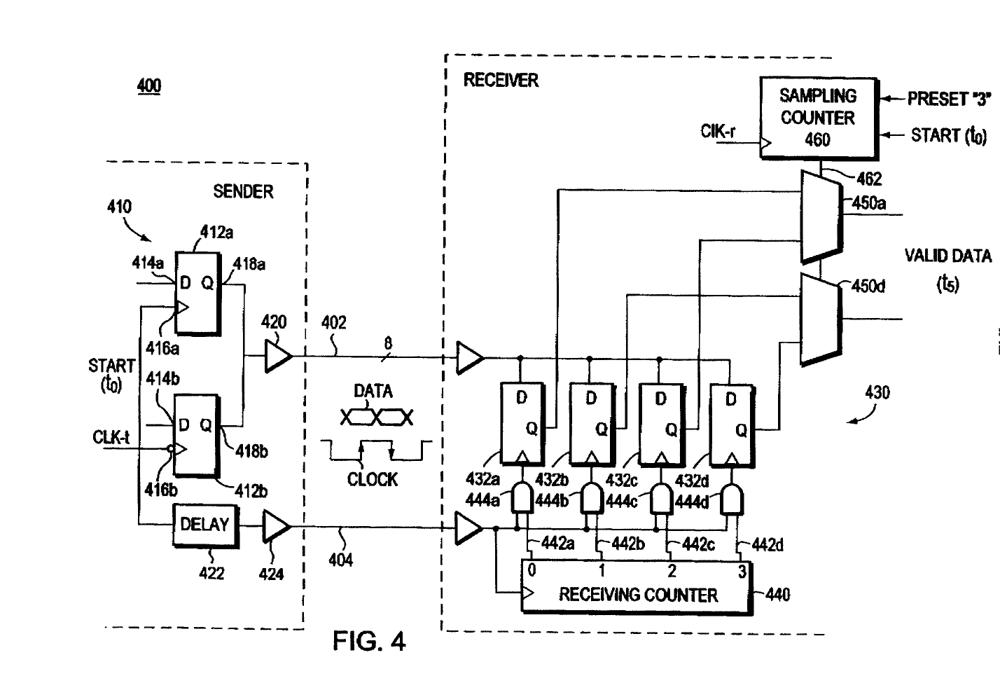

FIG. 4 is a schematic block diagram illustrating a synchronous clock forwarded interface circuit arrangement 400 within a QBB node 200 of the SMP system 100. Sender and receiver circuits are preferably contained within ASICs of the node and are interconnected by synchronous clock forwarded links, such as the unidirectional and bi-directional links 202, 204, 206. The synchronous clock forwarded link may comprise a data path, such as the 72-bit data path of link 204 coupling a processor and the QSD. In that case, the sender and receiver circuits are preferably resident within the processor and its corresponding processor interface circuit 320. In the illustrative embodiment, the data path is apportioned into 8 groups of 9 bits (referred to as a “bundle”), wherein each group has an accompanying clock signal. The circuit arrangement thus represents an 9-bit or byte “slice” of the 72-bit data path between the sender and receiver.

A global reference clock source (not shown) generates transmit and receive clock signals that are frequency matched and generally phase aligned within an acceptable range of skew; these generated clock signals are then distributed to each clock forwarded interface circuit of the sender and receiver in the SMP system. Thereafter, clock forwarded data, comprising data and an accompanying clock signal, are transmitted over the clock forwarded link coupling the sender and receiver. The clock forwarded link preferably comprises a data interconnect 402 for transporting the data and a clock interconnect 404 for transporting the accompanying clock signal. The bit times or “flits” of data transmitted over the interconnects are preferably small and may be clocked into the receiver interface circuits on both leading and trailing edges of the accompanying clock signal. As a result, the data are clocked into the circuits with substantial precision to ensure that each leading and trailing clock signal edge is aligned within an “eye” of each transmitted flit. In addition, the data are clocked into the receiver circuits in a manner that satisfies set-up and hold times of state devices (registers) within the receiver.

The transmitted data and accompanying clock signals are preferably transmitted by a sender in unison over data and clock interconnects that are matched in terms of lengths and materials. Such an arrangement reduces skew or variations between flits of data and their accompanying clock signals with respect to their relative placements on the matched interconnects. That is by having the clock signal accompany its associated data and by controlling the characteristics of the matched interconnects, the likelihood of the leading and trailing edges of a clock signal aligning with the eyes of the flits is substantially increased. Moreover, the variations between the clock signals and their accompanying groups of data bytes can be controlled.

Since data is transmitted on both the leading and trailing edges of a clock signal, data transmission circuitry 410 of the sender comprises two registers 412a,b (e.g., flip-flops). Each register includes a data input 414a,b that receives data for temporary storage in the register, a clock input 416a,b that receives a transmit clock (clk_t) signal used to “clock” the data into the register and a data output 418a,b that delivers the stored data for transmission to the receiver. Each register is also configured to store a byte or flit of data, with one register 412a transmitting data on the leading edge of the clock signal and the other register 412b transmitting data on the trailing edge of the signal (see non-inverted and inverted clock inputs 416a,b). The output of each register is provided to an input of a driver 420 that forwards the data over the data interconnect 402 to the receiver. In order to position the clock between data transmissions, and thereby avoid having the clock arrive at the receiver at the same time as the data, the data transmission circuitry 410 further comprises a delay element 422 within the clock signal path of the sender. The delay element 422 adds a delay to the clock signal to offset the clock relative to the data.

At the receiver, the transmitted data is stored in collection logic circuitry that, in the illustrative embodiment, is a multi-staged, serial input storage circuit (e.g., a data SILO) 430 comprising a plurality of 9-bit wide registers 432a-d, each configured to store a flit of data. A receiving counter 440 associated with the data SILO counts incoming flits of data using the clk_t signals accompanying the incoming flits. That is, each transmitted flit is clocked into a register 432 of the data SILO 430 at an increment of the receiving counter as enabled by the clk_t signal accompanying the flit.

Operationally, the receiving counter 440 initially resets to “0” and when a first flit of data (flit 0) arrives at the SILO 430, a first load enable signal is generated by the counter and provided to a first register (register 432a) from a first output (i.e., output 0) of the counter over line 442a. The clk_t signal accompanying flit 0 causes the counter 440 to generate the load enable signal; assertion of the load enable signal in conjunction with the clk_t signal (via logic gate 444a) loads flit 0 into register 432a. Meanwhile, the receiving counter 440 increments to “1” and when a second flit of data (flit 1) arrives at the data SILO 430, the accompanying clk_t signal triggers a second load enable signal that loads flit 1 into register 432b of the SILO 430.

The outputs of the data SILO registers are coupled to inputs of two multiplexers 450a,b, each configured to select data at one of its inputs for delivery to its output in response to a selection enable signal provided by a sampling counter 460 over line 462. The sampling counter 460 is enabled by the receive clock (clk_r) signal to retrieve data from the SILO 430. Two multiplexers are employed to essentially transition from a bit-time clock domain (i.e., where data is transmitted by the sender on the leading and trailing edges of a clock signal) to a native clock domain (i.e., where data is retrieved by the receiver on only the rising edge of a clock signal). In addition, the multiplexers 450 cooperate with the data SILO 430 to retrieve the stored data in a manner that compensates for worst case skew variations between clk_t and clk_r, and between flits of the sliced data path.

Specifically, the multi-staged configuration of the data SILO ensures that transmitted data settles within the SILO for a predetermined amount of time (i.e., the settle time) to compensate for worst case clock skew between the transmit and receive clock signals. As noted, the clk_r signal has the same frequency as the clk _t signal and is generally phase aligned within an acceptable range of skew. Each slice of the data path transports a flit of data and an accompanying clk_t signal; within each slice, it is desired that the clk_t signal be aligned within the eye of the data flit. However, there may be further variations or skew between each clock forwarded flit of the sliced data path. Therefore, the time needed to compensate for a worst case skew between the transported flits/slices is added to the settle time.

The data SILO 430 is preferably sized to accommodate worst case settling times. In particular, each transfer cycle consumes two registers 432 of the data SILO 430, thereby providing two extra registers for receiving data before having to overwrite the first two registers. As a result, the data SILO 430 includes 4 entries and provides two bit times or one cycle of settling time to cover worst case skew.

Assume, for example, that an initial flit is loaded into the data SILO 430 and, some time later, a subsequent flit is loaded into the SILO. These two data flits are thereafter selected for retrieval from the SILO 430 and provided at the outputs of the multiplexers 450 based on the settle time of the subsequent flit rather than the initial flit. That is, once it is assured that the second flit of data has settled within a register 432 of the data SILO 430, it is assumed that the first flit of data has settled in its register. As noted, the use of cooperating multiplexers 450a,b enables transition from a bit-time clock domain to a native clock domain. Thus, although data is loaded into the SILO 430 in 9-bit flits, that data is retrieved from the SILO in 16-bit words and, as a result, the bandwidth is effectively the same for both the sender and receiver.

In accordance with the present invention, a synchronous clock forwarding technique utilizes a complimentary pair of start events delivered to the sender and receiver that enable, e.g., the sampling counter at the receiver to synchronize with the data transmission circuitry at the sender. In particular, the start event at the sender starts clk_t used to enable the receiving counter 440 when loading the registers 432 of the data SILO 430 with data transmitted by the data transmission circuitry 410. Similarly, the start event at the receiver preloads and starts the sampling counter 460 for use in retrieving data from the registers of the SILO 430. The difference between the time at which the sampling counter 460 begins retrieving data and the time at which the data transmission circuitry 410 begins transmitting data comprises the transmit time (from the sender to the data SILO) and the settle time.

For example, assume three bit times are needed to transmit data from the input of the sender to the input of a register within the data SILO and two bit times are needed for the data to settle in that register. A total of five bit times transpires between the point at which the sender starts transmitting data and the point at which the receiver starts removing data from the SILO. Assume further that the start time for transmitting data is to and the sample time for receiving that data is t₅. The sampling counter 460 may thus be initialized to “0” at t₅ to guarantee that valid data is present at the outputs of multiplexers at time t₅.

On the other hand, assume the transmit clock begins running and the sampling counter begins counting at the same time (e.g., clk_t and clk_r=t₀). In order to guarantee that the sampling counter is initialized to “0” at t₅, a preset input to the sampling counter is initialized to a predetermined value (e.g., “3”) and a start input to the counter is initialized to time to. Therefore, if the start events for the clk_t and the clk_r signals occur at to and the sampling counter is preset to “3”, the sampling counter 460 initializes to “0” at time t₅ and the receiver samples (retrieves) the correct data from the appropriate register of the SILO.

In particular, the invention pertains to a technique for generating and delivering start events that initialize the sender and receiver with respect to “starting up”(activating) their respective transmit and receive clocks to thereby insure proper synchronous operation of their clock forwarded interface circuits. To that end, the inventive technique provides an initialization or broadcast mode that allows simultaneous synchronization of all clock forwarded interfaces and links in a node during power-up or reset sequences. The technique also provides a hot swap/add or multicast mode that allows synchronization of clock forwarded interfaces associated with a subset of the clock forwarded links within the QBB node during a “hot swap/add” procedure. In this latter mode, other clock forwarded interface circuits of the node may be activated and operational; accordingly, the multicast mode is a targeted synchronization process that activates selected clock forwarded interfaces without disturbing previously activated agents and associated links within the node.

As noted, each processor is coupled to the QSA via a pair of unidirectional clock forwarded address links and to the QSD via a bi-directional, clock forwarded data link. The IOP is coupled to the QSA via a unidirectional clock forwarded address link and to the QSD via a bi-directional clock forwarded data link. The GP is coupled to the QSD via a bi-directional clock forwarded data links and to the QSA via two unidirectional clock forwarded address links. Finally, each memory module is coupled to the QSD via a bi-directional clock forwarded data link. For a fully loaded QBB node, an aspect of the present invention involves activating these clock forwarded links and their respective clock forwarded link interfaces at the same time during a power up sequence.

As shown in FIGS. 2-4, each of the clock forwarded circuits of a given QBB node comprise two or more sub-circuits that are distributed across multiple agents or ASICs. The clock forwarded circuit of each processor P, for example, includes processor address and data sub-circuits, as well as the QSA BE CNTL sub-circuit 370 and the QSD INT sub-circuit 320. The GP's clock forwarded circuit includes GPA interface sub-circuits, GPD interface sub-circuits, the QSA BE CNTL sub-circuits 390a and 390b, and the QSD INT sub-circuits 340a and 340b. The IOP's clock forwarded circuit includes IOA interface sub-circuit, IOD interface sub-circuit, the QSA BE CNTL sub-circuit 380 and the QSD INT sub-circuit 330. Each memory module's clock forwarded circuit includes a MEM interface sub-circuit and QSD INT sub-circuit 310.

For any given clock forwarded interface circuit to be “started up”, or synchronized, start signals must be delivered to each sub-circuit of the given circuit at substantially the same time. Further, to “start up” all, or at least multiple, clock forwarded interface circuits within a QBB node at the same time, start signals must be delivered to all or multiple sub-circuits at the same time. A conventional start signal delivery system would typically include a central component with a set of discreet start signal wires fanning out to each of the multiple clock forwarded circuits. Each set of wires would contain one wire for each unique ASIC or chip within which one of the clock forwarded circuit's sub-circuits resides. The set of wires associated with a processor's clock forwarded circuit, for example, would include one wire for the processor P itself, one wire for the QSA ASIC and one wire for each of the four QSD ASICs that collectively comprise the QSD INT sub-circuit 320. Similarly, the set of wires associated with the GP's clock forwarded circuit would include one wire for the GPA ASIC, one wire for the GPD ASIC, one wire for the QSA ASIC, and one wire for each of the four QSD ASICs. This solution, however, involves many discrete signals crossing multiple modules and connectors, and more importantly, many discrete signals into the ASICs of the QBB node. The QSA and QSD ASICs, for example, would be required to reserve 10 pins to support such a system. ASICs, however, such as the QSA and QSD, are often severely pin limited. As a result, an alternative delivery system, with lower pin count requirements, is required.

As indicated above, the preferred embodiment of the present invention includes two start signal delivery systems: an initialization delivery system and a hot swap/add delivery system. The initialization delivery system is used when a node is first powered on and initialized. It starts the clock forwarded circuits corresponding to each populated memory module, each populated processor agent, the global port agent, if it is populated and the IOP agent. To minimize electrical disturbance and corruption in the system, the initialization delivery system omits the delivery of start signals to processor, memory module and global port agents that are not populated. The hot swap/add delivery system, on the other hand, is used when processor agents are added to a QBB node, while some agents are already initialized and operating. It delivers start signals only to the clock forwarded circuits of the newly added processor agent(s) without disturbing activity associated with circuits that have already been started and are operating. By combining the use of discrete start signal wires, a serial bit stream interface and pre-existing command interconnects, the present invention minimizes ASIC pin utilization. It uses these various resources, combined with some combinatorial logic in the QSA to deliver start signals to all of the sub-circuits of all of the clock forwarded circuits of all populated agents within the node at substantially the same time.

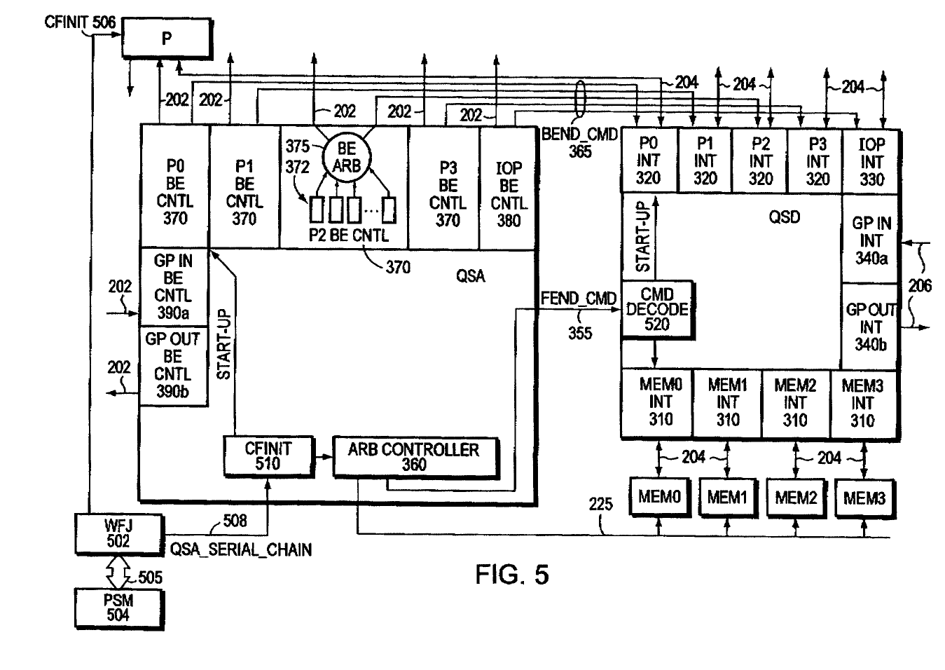

FIG. 5 is a highly schematized diagram illustrating the interaction between agents of a QBB node when synchronizing clock forwarded interface circuits of the agents (including the local switch) in accordance with the present invention. A special “junk”(WFJ) device 502 is located on, e.g., a QBB backplane, and functions as an intermediary that collects information from various agents of the QBB node. One such agent is a power system manager (PSM) microcontroller 504 that is coupled to the WFJ device 502 over a command bus 505. The PSM microcontroller 504 resides on a QBB backplane of each node and is generally responsible for powering-up the agents of the QBB node, along with managing their self-tests and their populations. To that end, the PSM performs inventory control functions, including gathering of configuration information, such as presence of agents in the node. An example of a PSM microcontroller that may be advantageously used with the present invention is described in copending and commonly assigned U.S. patent application Ser. No. 09/545,073, titled Communication Path For Facilitating Intelligent Subsystem To System Communication In A Large Computer System, filed Apr. 7, 2000, which application is hereby incorporated by reference as though fully set forth herein. The WFJ device 502 is also coupled to each processor in its QBB node by a cf_on signal and a cpu_present signal. When asserted, each cpu_present signals indicates to the WFJ device 502 that the respective processor is present and powered on, while the cf_on signal when asserted, indicates that the processor's associated clock forwarding interfaces are active. At power-up of the QBB node, and after reset, all of the processors' cf_on signals will be deasserted. The WFJ device 502 is also coupled to each memory module and the GP by four mem_present wires and one gp_present wire, respectively. When asserted, these wires indicate that the respective module or agent is present. In the illustrative embodiment, there is no IOP_present wire because the IOP is implemented on the QBB backplane and, therefore, is always be present.

The WFJ device 502 is also coupled to each processor of the QBB node over a cfinit line 506 carrying start signals. A QSA_serial_chain line 508 couples the WFJ device to a CFINIT logic circuit 510 of the QSA for transporting a QSA serial chain message stream. The CFINIT circuit 510 comprises combinational logic organized as a unique command port that interacts with clock forwarded interface circuits to distribute clock forwarding synchronization messages among the agents of the QBB node. As described herein, these synchronization messages are used as start events that “start up”(activate) the clock forwarded interface circuits to thereby insure proper synchronous operation of those circuits.

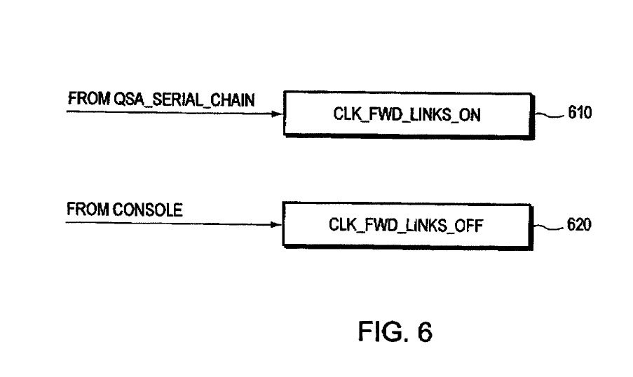

FIG. 6 is a schematic block diagram of various registers contained within the CFINIT logic of the QSA. A clk_fwd_links_on register 610 stores the contents of the serial chain message provided by the WFJ device 502 (FIG. 5) for use by console system software operating on the processor. Preferably, the clk_fwd_links_on register 610 is initially set (initialized) to “0”. A clk_fwd_links_off register 620 is also provided within the CFINIT logic for use by the console software when “turning-off”(deactivating) clock forwarded links within the QBB node and SMP system. Collectively, the contents of these two registers determine whether a clock forwarded link is currently activated. For example, when a serial chain message arrives at the CFINIT logic, its contents are compared with the contents of the clk_fwd_links_on register 610 and the clk_fwd_links_off register 620 to determine which clock forwarded links are currently activated and which links require activation.

Initialization Delivery System

When a given QBB node is being powered up or reset, the PSM 504 initiates the clock forwarded start signal distribution by issuing a QBB_INIT command to the WFJ device 502. In response to a QBB_INIT command, the WFJ device 502 begins a clock forward start signal sequence using qsa_serial_chain line 508 and the cfinit lines 506. Specifically, the WFJ device 502 creates a bit mask indicating which agents and/or modules are to be initialized. The bit mask preferably includes one bit for each agent in the QBB node which may or may not require initialization. The mask need not include a bit for the IOP, which, as described above, is always present and thus always requires initialization. The WFJ device 502 creates the bit mask by setting each bit in the mask for which the corresponding processor, GP and/or memory module has its present signal asserted. Since all clock forwarding circuits are inactive after reset, the WFJ device 502 need not consider the cf_on signals.

The WFJ device 502 next completes its portion of the clock forwarding start signal sequence by transmitting the bit mask as a serial bit stream to the QSA over qsa_serial_chain line 508, and by asserting the appropriate cfinit lines 506 to their associated processors. The appropriate cfinit lines 506 are defined to be the set of processor's whose associated cpu_present signals are asserted. By delivering the serial bit stream and asserting the cfinit signals, the WFJ device 502 directly delivers start signals to the clock forwarding sub-circuits of the populated and operational processors and indirectly via the QSA delivers start signals to all other clock forwarding sub-circuits. The WFJ device 502 delays the assertion of the cfinit signals by a fixed number of system clock cycles relative to the transmission of the serial bit stream to the QSA so that the start signals issued directly to the processors arrive at their respective clock forwarding sub-circuits at substantially the same time as those distributed or fanned out by the QSA.

In response to a clock forwarding initialization serial bit stream via line 508, the CFINIT logic 510 of the QSA logs clock forwarding interface status into registers, including a single bit init_flag register and a 5-bit qsa_port_enable register, which may correspond to the clk_fwd_links_on register 610. The init_flag register is used to indicate whether or not a clock forwarding initialization serial chain has been transmitted to the QSA since the QSA was reset, while the qsa_port_enable register is used to indicate which of the QSA's processor and GP interfaces are active. Upon reset, the init flag register is preferably deasserted or set to the clear state, indicating that no serial chain has been received since the occurrence of the reset event, while the qsa_port enable register is set such that all bits are clear, indicating that all processor and GP clock forwarded interfaces have been reset to the inactive state. When a clock forwarding initialization serial bit stream arrives at CFINIT logic 510, it asserts or sets init flag register and each bit of the qsa_port enable register for which there is a corresponding bit set in the received serial bit stream.

The QSA also propagates clock forwarding start signals in response to receiving the serial bit stream. Specifically, the CFINIT logic 510 is directly coupled to the following QSA clock forwarding sub-circuits: IOP BE CNTL 380, GP BE CNTLs 390a and 390b, and processor BE CNTLs 370 by internal QSA start-up signal lines. The CFINIT logic circuit 510 is also coupled to Arb bus 225 and to the Fend_Cmd bus 355 via Arb controller 360. When a clock forwarding initialization serial bit stream arrives at the CFINIT logic circuit 510, it propagates clock forwarding start signals to all, or some sub-set, of these clock forwarding sub-circuits, in accordance with the bits set in the serial bit stream. The CFINIT logic 510 also issues a special SYNC command on Arb bus 225, and a special CFINIT command on Fend_Cmd bus 355 through Arb controller 360. The SYNC command is used to distribute clock forwarding start signals to the clock forwarding sub-circuits in the GPA, GPD, IOA, IOD, MPA and MPD ASICs. The SYNC command is preferably not accompanied by a mask since only those ASICs that are properly reset and powered (i.e., only those ASICs eligible for clock forwarding initialization) will respond to the SYNC command.

The CFINIT command on Fend_Cmd bus 355 is used to distribute clock forwarding start signals to the clock forwarding sub-circuits on the QSD. The CFINIT command is accompanied by a 9-bit bit mask that is derived from the serial bit stream, wherein each bit in the mask represents the clock forwarding sub-circuits associated with the GP, each of the four possible memory modules and each of the four possible processors in the QBB node. The internal QSA start signals are delayed for a fixed number of clock cycles, such that they arrive at their associated QSA clock forwarding sub-circuits at substantially the same time as start signals arrive at the QSD, GPA, GPD, IOA, IOD, MPA and MPD sub-circuits via front end command bus 355 and Arb bus 225, and the processor start signals issued by the WFJ device 502.

As described above, Arb bus 225 is directly coupled to the IOA and any populated GPA and MPA ASICs. In response to the issuance of a SYNC command on the Arb bus 225, each of these ASICs that is properly powered and reset, propagates a clock forwarding start signal to each of its own clock forwarding sub-circuits, if present, and to each of the clock forwarding sub-circuits in its associated IOD, GPD or MPD ASICs. For example, the IOA propagates a start signal to its IOA sub-circuit and the IOD sub-circuits. Similarly, the GPA propagates start signals to its GPA sub-circuits and the GPD sub-circuits. The MPA propagates start signals to the MPD sub-circuits only. In each case, the start signals for the IOD, GPD and MPD sub-circuits are transmitted between ASICs by their inter-ASIC command buses 205, 207, 209. The GPA and IOA sub-circuit start signals are delayed by a first fixed number of clock cycles, while the inter-ASIC signals that are used to generate the start signals for the GPD, IOD and MPD sub-circuits are delayed by a second fixed number of clock cycles, such that the start signals arrive at their associated clock forwarding sub-circuits at substantially the same time as the start signals for the QSD sub-circuits via the front end command, as well as the internal QSA start signals, and the processor start signals issued by the WFJ device 502.

As also described above, Fend_Cmd bus 355 is coupled directly to all four QSD ASICs. In response to a CFINIT command on the Fend_Cmd bus 355, each QSD propagates a clock forwarded start signal to all, or to some subset, of its clock forwarding sub-circuits, in accordance with the mask received with the CFINIT command. No delay is required in the delivery of the QSD start signals, since commands on the Fend_Cmd bus 355 are nominally generated 12 clock cycles after their associated command on Arb bus 225 (e.g., the CFINIT command is generated 12 cycles after the SYNC command). Instead, with expedient delivery of QSD start signals, and appropriate delays in the WFJ device 502, QSA, IOA, GPA and all four MPAs, the start signals for all targeted clock forwarding sub-circuits within the node can be delivered at substantially the same time.

Given the pin count constraint associated with the ASICs, the present invention provides a technique that leverages the pre-existing buses and interconnects within the QBB node to deliver start-up events to the proper clock interface circuits within the node. That is, the present invention utilizes the cfinit start event, along with the serial chain message and its derived sync and start-up commands, to coordinate activation of the clock forwarded interface circuits throughout the QBB node. The arrival of the following pairs of commands result in the following events. The arrival of the sync commands at the QSDs and the MPDs synchronize the memory-to-QSD and the QSD-to-memory links. The arrival of the sync commands at the QSDs and the IODs synchronize the I/O-to-QSD and the QSD-to-I/O links. The arrival of the sync commands at the QSDs and the GPDs synchronize the GP-to-QSD and the QSD-to-GP links. The arrival of the sync command at the QSDs and the arrival of the cfinit signals at the processors synchronize the processor-to-QSD and the QSD-to-processor links. The sum total of these events represents the complete synchronization of all clock forwarded links in the system.

Hot Swap/Add Delivery System

The hot swap/add delivery system uses many of the same techniques and mechanisms as the initialization delivery system described above The term “hot swap” is used herein to refer to a four step process. The steps of this process include: (1) the operational exclusion of an agent or module from an operating system, (2) the physical removal of the agent or module, (3) the physical replacement of the removed agent or module, and (4) the operation inclusion of the replacement agent or module into the operating system. The term “hot add” is used to refer to a two step process: (1) adding a new physical agent or module to a vacant location in an operating system, and (2) operationally including the new agent into the operating system. In the preferred embodiment, only processor modules may be hot swapped or hot added. Furthermore, the system and method of the present invention pertain to the first step of the hot swap procedure, the operational exclusion step, which involves the stopping of a processor's clock forwarded interfaces, and the fourth step, the operation inclusion step, which involves the startup of a processor's clock forwarded interfaces. They also pertain to the second step of the hot add procedure, which involves the startup of a processor's clock forwarded interfaces.

The procedure for stopping a given processor's clock forwarded interface is executed by code running on one of the processors within a given processor's QBB node or within another QBB node of the system. The procedure involves writing a mask value to the qsa_port_enable register. Each bit in the mask uniquely corresponds to one bit in qsa_port_enable register, and the bits associated with any processors whose clock forwarding interfaces are to be stopped are asserted or set. In response to this write, the QSA clears the qsa_port enable register bits, and stops the clock forwarded interfaces that correspond to the asserted or set bits in the mask.

After a clock forwarding stopping procedure, the final state of the QSA, with the appropriate qsa_port_enable register bits clear, is the same had the stopped processors never been included at power up. Thus, the inclusion of a new processor at the end of a hot swap procedure proceeds in an identical manner as the inclusion of a new module in a hot add procedure, and the clock forwarding start signal distribution system used for hot swap is the same as that used for hot add.

The start signal distribution system for hot swap and hot add is similar in many respects to the initialization start signal distribution system. In particular, as with the initialization event, a hot swap/add event begins with a command from the PSM 504 to the WFJ device 502. In this case, the command is a HOT_SWAP command instead of the QBB_INIT command described above. In response to the HOT_SWAP command, the WFJ device 502 creates a serial bit stream for the QSA exactly as it did in response to the above described QBB_INIT command. That is, the WFJ device 502 creates a bit mask by setting each bit in a mask for which the corresponding processor, GP or memory module has its present signal asserted. The WFJ device 502 then completes its portion of the clock forwarding start signal sequence by transmitting the bit mask as a serial bit stream to the QSA over the qsa_serial_chain line 508, and by asserting the appropriate cfinit lines 506. As is the case for an initialization start signal distribution sequence, the appropriate cfinit lines 506 are defined to be the set of processors whose associated cpu_present signals are asserted and whose associated cf_on signals are deasserted. However, since hot swap and hot add events are not associated with reset events, there may be some bits set in the serial bit stream associated with processors that already have their cf_on signal asserted. Accordingly, there may be some bits set in the bit stream for which there is no associated assertion of a cfinit line 506. Furthermore, as in the initialization case, the WFJ device 502 delays the assertion of any cfinit lines 506 by a fixed number of system clock cycles relative to the transmission of the serial bit stream via line 508 to the QSA, so that the start signals issued directly to the processors arrive at their respective clock forwarding sub-circuits at substantially the same time as those distributed or fanned out by the QSA.

In response to the serial stream, the CFINIT logic 510 at the QSA first makes a determination as to whether the serial bit stream represents a clock forwarding initialization event or a hot swap/add event. Since the construction of the bit stream is identical for both event types, the CFINIT logic 510 preferably uses internal state to make this determination. More specifically, the CFINIT logic 510 examines the state of the init flag register. As described above, the init_flag register is cleared by reset and set by a clock forwarding initialization serial bit stream. Given that both initialization and hot swap/add bit streams are identical, however, it is more accurate, but equivalent, to describe the init_flag register as being set by the first serial bit stream to follow reset. Therefore, if a serial bit stream arrives when the init_flag register is clear (i.e., this is the first bit stream following reset), then the CFINIT logic 510 determines that the serial stream is an initialization stream. If a serial bit stream arrives when the init_flag register is set (i.e., this bit stream is after the initialization bit stream), then the CFINIT logic 510 determines that the serial bit stream is a hot swap/add stream.

Assuming the CFINIT logic 510 determines that the given serial bit stream corresponds to a hot swap/add start signal sequence, it then determines which processors' sub-circuits require start signals. As the serial bit stream includes bits for all present processors, including those whose clock forwarding interfaces are in the active state, the CFINIT logic 510 again uses state in the QSA to identify the new processors. As the qsa_port_enable register is written with a mask upon the arrival of an initialization serial bit stream, and as this mask is updated during any hot swap interface stoppage procedure, the state of the qsa_port_enable register can be used to identify the new processors that require start signals. Specifically, the processor mask bits from the serial bit stream are compared to the processor mask bits in the qsa_port_enable register. Any processor whose associated bit is set in the serial bit stream mask and whose bit is not set in the qsa_port_enable mask, is identified as new and thus requiring a start signal.

Once the CFINIT logic 510 has identified the set of processors requiring start signals, start signals are preferably distributed to the QSA and QSD clock forwarding sub-circuits associated with those processors. The QSA preferably distributes start signals to the QSA sub-circuits through the STARTUP signals as described above for the initialization start signal distribution. However, as hot swap start signal sequences typically occur while other active processors are making use of the Arb bus 225 and the Fend_Cmd bus 355 for normal memory space and I/O space transactions, these interconnects are preferably not used in distributing start signals to the respective clock forwarding sub-circuits at the QSD. Instead, in the case of a hot swap/add start signal distribution, the QSA distributes start signals to the QSD through the Bend_Cmd busses 365. As described above, a separate Bend_Cmd bus 365 exists for each processor. Accordingly, in response to a hot swap/add serial bit stream, the QSA preferably transmits a special “SYNC” encoding on each of the Bend_Cmd busses 365 associated with the processors requiring start signals. The distribution of the start signals to the QSA clock forwarding sub-circuits are delayed by a fixed number of clock cycles so that they arrive at their associated sub-circuits at substantially the same time as the SYNC commands arrive at the QSD sub-circuits and the cfinit signals arrive at the processors' clock forwarding sub-circuits.

When removing a hot-swapped processor, the console system software may utilize the clk_fwd_links_off register 620 to disable the appropriate bit representative of a hot-swapped processor and thereby deactivate the clock forwarded links associated with that processor. In response to a write operation issued by the console to the clk_fwd_links_off register disabling the appropriate bit, the CFINIT logic 510 issues a deactivate command to the appropriate processor controller circuit 370 of the QSA. The CFINIT logic further issues another deactivation command over the front-end command bus 355 to the appropriate processor interface circuit 320 of the QSD.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method for synchronizing a plurality of clock forwarded interface circuits of a node of a multiprocessor system, the node including a plurality of agents, including one or more processor agents, coupled to a local switch over clock forwarded links attached to the clock forwarded interface circuits, the method comprising the steps of:
determining which agents are present on the node;
issuing a clock forwarded initialization (cfinit) signal to each of the one or more processor agents determined to be present; and
issuing a serial chain message to the local switch, the serial chain message comprising a serial bit stream identifying the agents determined to be present on the node.

2. The method of claim 1 wherein the local switch includes a plurality of sender and receiver sub-circuits of the clock forwarded interface circuits, the method further comprising the step of deriving one or more start-up commands from the serial chain message, each start-up command activating a selected sender and/or receiver sub-circuit of the local switch.

3. The method of claim 2 further comprising the step of deriving one or more synchronization (sync) commands from the serial chain message, the one or more sync commands activating selected sender and/or receiver sub-circuits of the local switch.

4. The method of claim 3 further comprising the steps of:
loading the serial bit steam with a mask;
comparing the mask of the serial bit stream with the contents of a register to determine which sender and/or receiver sub-circuits are to receive the start-up commands and the sync commands.

5. The method of claim 4 wherein the determining step comprise the step of receiving an indication from each agent indicating whether the respective agent is present on the node.

6. The method of claim 5 wherein the one or more sync commands include one or more internal synch commands internal relative to the local switch and at least one external synch command relative to the local switch for receipt by one or more agents of the node.

7. The method of claim 6 wherein issuance of the internal synch commands are delayed relative to issuance of the one or more external synch commands to ensure that the internal and external synch commands are received at the same time.

8. The method of claim 7 wherein the issuance of the cfinit signal to each of the one or more processor agents is delayed relative to the issuance of the serial chain message to ensure that the cfinit signals are received at the same time as the one or more synch commands.

9. The method of claim 8 wherein
the local switch includes a quad switch address (QSA) circuit and one or more quad switch data (QSD) circuits, and
the agents of the node include a global port (GP) circuit, an input/output port (IOP) circuit and one or more memory port data (MPD) circuits.

10. A method for synchronizing clock forwarded interface circuits associated with a hot added processor of a node of a multiprocessor system, the node including a plurality of processors and a local switch coupled to the processors over clock forwarded links attached to the clock forwarded interface circuits, the method comprising the steps of:
determining which processors are present on the node;
determining which processor clock forwarded interface circuits are on;
issuing a clock forwarded initialization (cfinit) signal to each processor that is present, but whose processor clock forwarded interface circuit is not on; and
issuing a serial chain message to the local switch, the serial chain message comprising a serial bit stream identifying the processors determined to be present on the node.

11. The method of claim 10 wherein the local switch includes a plurality of sender and receiver sub-circuits of the clock forwarded interface circuits, the method further comprising the step of deriving one or more start-up commands from the serial chain message, each start-up command activating a sender and/or receiver sub-circuit of the local switch associated with the hot added processor.

12. The method of claim 1 1 further comprising the step of deriving one or more synchronization (sync) commands from the serial chain message, the one or more sync commands activating one or more sender and/or receiver sub-circuits of the local switch associated with the hot added processor.

13. The method of claim 12 wherein
the local switch includes a quad switch address (QSA) circuit and one or more quad switch data (QSD) circuits coupled by a front end command (Fend_Cmd) bus and one or more back end command (Bend_Cmd) busses, and
the one or more synch commands are transmitted from the QSA circuit to the one or more QSD circuits via the Bend_Cmd busses.

14. Apparatus for synchronizing clock forwarded interface circuits of a multiprocessor system having a plurality of nodes interconnected by a hierarchical switch, each node including a plurality of agents coupled to a local switch over clock forwarded links attached to the clock forwarded interface circuits, the apparatus comprising:
an intermediary device coupled to the agents of the system and configured to collect information from those agents; and
command port logic of the local switch coupled to the intermediary device, the command port logic configured to interact with the clock forwarded interface circuits of the system to distribute synchronization messages among the agents of each node, the synchronization messages representing start events that activate the clock forwarded interface circuits to thereby insure proper synchronous operation of the circuits.

15. The apparatus of claim 14 wherein each clock forwarded link is configured to transport clock forwarded data comprising data and an accompanying clock signal, and wherein the clock forwarded link comprises a data interconnect for transporting the data and a clock interconnect for transporting the accompanying clock signal.

16. The apparatus of claim 15 wherein the clock forwarded interface circuits coupled to each clock forwarded link function as sender and receiver interface circuits of clock forwarded data transported over the links.

17. The apparatus of claim 16 wherein the command port logic is a CFINIT logic circuit and wherein the local switch includes a plurality of sender and receiver interface circuits coupled to the clock forwarded links.

18. The apparatus of claim 17 wherein the CFINIT logic is coupled to the intermediary device over a first signal line adapted to transport a serial chain message, the serial chain message comprising a serial bit stream indicating the number of agents present in the node, wherein the agents include processors, memories, an input/output port (IOP) and a global port (GP).

19. The apparatus of claim 18 wherein the synchronization messages include sync and start-up commands, and wherein local switch derives the sync and start-up commands from the serial chain, the start-up command representing a start event that activates selected sender and receiver interface circuits of the local switch.

20. The apparatus of claim 19 wherein the processors include sender and receiver interface circuits, and wherein the intermediary device is coupled to each processor over a second signal line adapted to transport a cfinit signal representing a start event that activates the sender and receiver interface circuits of each processor.

21. The apparatus of claim 20 wherein each of the memories, IOP and GP include sender and receiver interface circuits, and wherein the sync command represents a start event that activates the sender and receiver interface circuits of the memories, IOP and GP.

22. The apparatus of claim 21 wherein the sender interface circuit includes data transmission circuitry comprising two registers having outputs coupled to a first driver, the registers configured to temporarily store data and the first driver configured to transmit the stored data over the data interconnect to the receiver interface circuit, wherein one of the registers transmits the stored data on a leading edge of the transmit clock signal and the other of the registers transmits the stored data on a trailing edge of the transmit clock signal.

23. The apparatus of claim 22 wherein the data transmission circuitry further comprises a delay element coupled to a second driver configured to forward the transmit clock signal over the clock interconnect to the receiver interface circuit.

24. The apparatus of claim 23 wherein the receiver interface circuit comprises:
a multi-staged storage circuit having a plurality of registers, each configured to store the data transmitted over the data interconnect; and
a receiving counter coupled to the multi-staged storage circuit and configured to count the transmitted data using the transmit clock signal forwarded over the clock interconnect accompanying the transmitted data.

25. The apparatus of claim 24 wherein the receiver interface circuit further comprises
a sampling counter enabled by a receive clock signal to retrieve data from the multi-staged storage circuit; and
a plurality of multiplexers connected to the sampling counter and the multi-staged storage circuit, the multiplexers enabled to select the retrieved data from the storage circuit in response to selection enable signals provided by the sampling counter.
